(19) United States
(12) Patent Application Publication
(10) Pub. No.: US 2014/0041476 A1
(43) Pub. Date: Feb. 13, 2014

(54) DRIVING GEAR PHOTOSENSITIVE DRUM

(71) Applicants: Shih-Hsiung Huang, Taichung City (TW); Shin-Yi Chen, Taichung City (TW)

(72) Inventors: Shih-Hsiung Huang, Taichung City (TW); Shin-Yi Chen, Taichung City (TW)

(21) Appl. No.: 13/570,800

(22) Filed: Aug. 9, 2012

(51) Int. Cl. F16H 55/12

(52) U.S. Cl. 74/434

(57) ABSTRACT

A driving gear includes a shell for fixed connection with a photosensitive roller, a coupling member detachably mounted inside the shell, and a driving member for being driven by a driving shaft located inside a printer. The shell includes two convexities and a rib for engaging two hook pieces and a fitting slot of the coupling member respectively. The coupling member includes a tunnel and a limiting portion located inside the tunnel. The driving member includes a first end portion located between the limiting portion and a bottom portion of the shell, a second end portion extending out of the coupling member, and a protrusion protruding from the first end portion and located in a limiting slot of the coupling member. Therefore, it will be not difficult for the user to install or detach the driving gear to or from the photosensitive roller.

### BACKGROUND OF THE INVENTION

1. Field of the Invention

The present invention relates generally to a photosensitive drum mounted to a printer and more particularly, to a driving gear for a photosensitive drum.

2. Description of the Related Art

As disclosed by U.S. Pat. No. 7,885,575, a drive transmitting means of a photosensitive drum is formed of a cylindrical shell to which a coupling member is mounted via a spherical member and a pin and to one end of which a cover is fixed. In light of the structure, the coupling member is pivotable toward every direction relative to the shell but is not rotatable on its own axis, and the coupling member is axially movable within a small distance only. In this way, the coupling member can be driven by a drive shaft mounted inside a printer to further make a photosensitive roller fixedly connected with the shell rotate.

When the photosensitive roller is damaged, a user can detach the coupling member, the spherical member, and the pin from the shell on his or her own by the method disclosed in the aforesaid patent and then install a new photosensitive roller to the shell along with the spherical member and the pin. However, it is actually quite difficult for the detachment and installation.

In fact, in view of the aforesaid difficulty of the installation and detachment, before the photosensitive drum is finished to leave the factory, the assembler can assemble the whole drive transmitting means and then fasten the shell to the photosensitive roller, but the location and pivoting action of the coupling member make the shell uneasily be fastened to the photosensitive roller. In other words, no matter when the user installs the drive transmitting means to the photosensitive roller for the first time or replaces the damaged photosensitive roller, it will be difficult for the user to install or detach the same. Therefore, the drive transmitting means of the conventional photosensitive drum needs further improvement.

### SUMMARY OF THE INVENTION

The primary objective of the present invention is to provide a driving gear for a photosensitive drum, which can effectively eliminate the drawbacks of that of the conventional photosensitive drum.

The foregoing objective of the present invention is attained by the driving gear composed of a shell, a coupling member, and a driving member. The shell includes a bottom portion, an opening opposite to the bottom portion, an inner surface located between the opening and the bottom portion, two convexities protruding from the inner surface, and at least one rib located at the bottom portion. Each of the convexities includes a bottom side facing the bottom portion. The coupling member includes a first end, a second end opposite to the first end, a tunnel extending from the first end to the second end, an internal wall surface located inside the tunnel, a limiting slot recessed from the internal wall surface, two hook pieces protruding outward, at least one fitting slot recessed from the first end toward the second end, and a limiting portion located inside the tunnel. The limiting slot is provided with an entrance located at the first end. The coupling member is detachably mounted inside the shell in such a way that the first end of the coupling member faces the bottom portion of the shell. Each of the two hook pieces is engaged with the bottom side of one of the two convexities. The fitting slot is engaged with the rib of the shell. The driving member includes a first end portion mounted inside the tunnel of the coupling member, a second end portion extending out of the second end of the coupling member, and at least one protrusion protruding from the first end portion. The first end portion of the driving member is confined between the limiting portion of the coupling member and the bottom portion of the shell. The protrusion is located inside the limiting slot of the coupling member.

In light of the above structure, the second end portion of the driving member can be driven for rotation by a driving shaft located inside a printer to drive the coupling member and the shell for rotation to further make the photosensitive roller fixedly connected with the shell rotate. The photosensitive drum inclusive of the driving gear is assembled by that the driving member and the coupling member are combined together, then the shell is fixed to the photosensitive roller, and finally the coupling member is combined with the shell. Besides, the driving gear allows the assembler or user to easily combine or separate the coupling member and the shell. Therefore, no matter when the user installs the driving gear to the photosensitive roller for the first time or mounts the driving member and the coupling member to the shell and a new photosensitive roller instead of the damaged one, it will not be difficult for the user to install or detach the driving gear.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a first preferred embodiment of the present invention;

FIG. 2 is a partially exploded view of the first preferred embodiment of the present invention;

FIG. 3 is an end view of the first preferred embodiment of the present invention;

FIG. 4 is a sectional view taken from a line 4-4 indicated in FIG. 3;

FIG. 5 is a perspective view of a part of the first preferred embodiment of the present invention;

FIG. 6 is an end view of the part of the first preferred embodiment of the present invention shown in FIG. 5;

FIG. 7 is a sectional view taken from a line 7-7 indicated in FIG. 6;

FIG. 8 is an exploded view of the first preferred embodiment of the present invention without the shell;

FIG. 9 is a perspective view of the first preferred embodiment of the present invention without the shell;

FIG. 10 is a sectional view of the first preferred embodiment of the present invention;

FIG. 11 is a partially exploded view of a second preferred embodiment of the present invention;

FIG. 12 is a sectional view taken from a line 12-12 indicated in FIG. 11;

FIG. 13 is an end view of a part of the second preferred embodiment of the present invention;

FIG. 14 is a partially exploded view of a third preferred embodiment of the present invention, and

FIG. 15 is an end view of a part of the third preferred embodiment of the present invention.

### DETAILED DESCRIPTION OF PREFERRED EMBODIMENTS

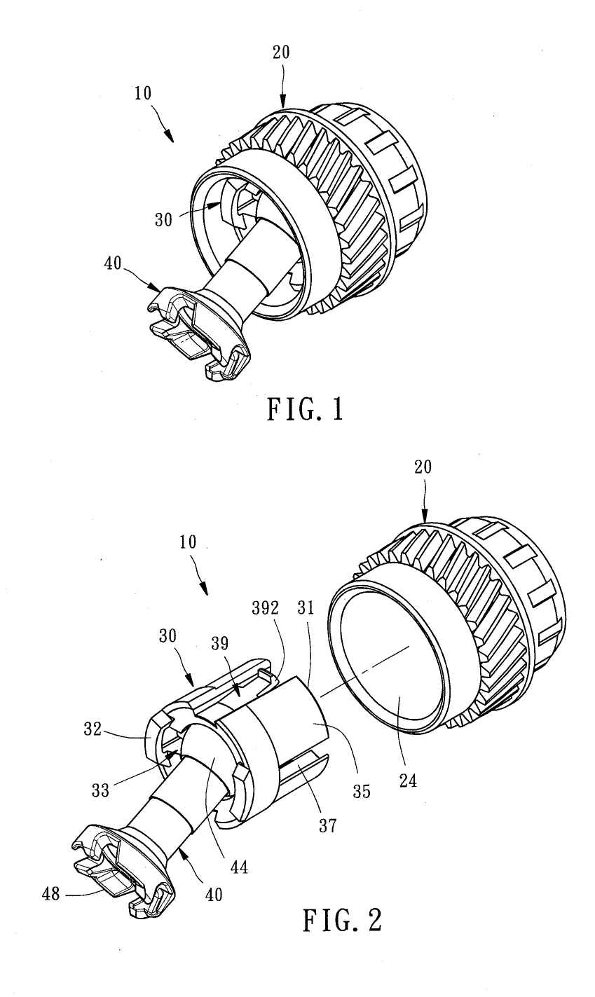

Referring to FIGS. 1-2, a driving gear 10 constructed according to a first preferred embodiment of the present invention is composed of a shell 20, a coupling member 30, and a driving member 40. The detailed descriptions and operations of these elements as well as their interrelations are recited in the respective paragraphs as follows.

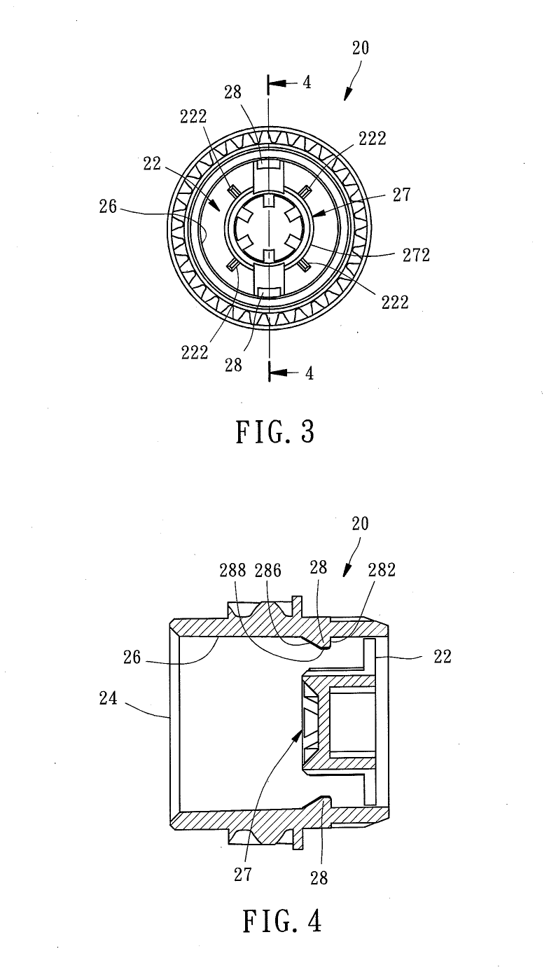

Referring to FIGS. 3-4, the shell 20 includes a bottom portion 22, an opening 24 opposite to the bottom portion 22, an inner surface 26 located between the opening 24 and the bottom portion 22, a support portion 27 located at a center of the bottom portion 22, and two convexities 28 protruding from the inner surface 26. The bottom portion 22 has four ribs 222 arranged radially and equidistantly. Each of the convexities 28 has a bottom side 282 facing the bottom portion 22 and a guiding bevel 286 facing the opening 24. The guiding bevel 286 and the bottom side 282 are located at two sides of a vertex 288 of the corresponding convexity 28, respectively.

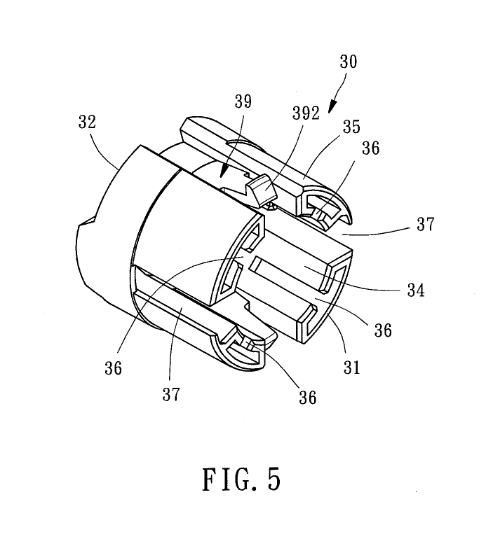

Referring to FIGS. 5-7, the coupling member 30 includes a first end 31 and a second end 32 opposite to the first end 31, a tunnel 33 extending from the first end 31 to the second end 32, an internal wall surface 34 located inside the tunnel 33, an external wall surface 35 opposite to the internal wall surface 34, four fitting slots 36 opened on the internal wall surface 34 and recessed from the first end 31 toward the second end 32, two limiting slots 37 recessed from the internal wall surface 34, two limiting portions 38 located inside the tunnel 33 and spaced from each other by the two limiting slots 36, and two springy portions 39 extending from the second end 32 toward the first end 31 and inclined outward. Each of the two springy portions 39 is provided at a distal end thereof with a hook piece 392 protruding outward.

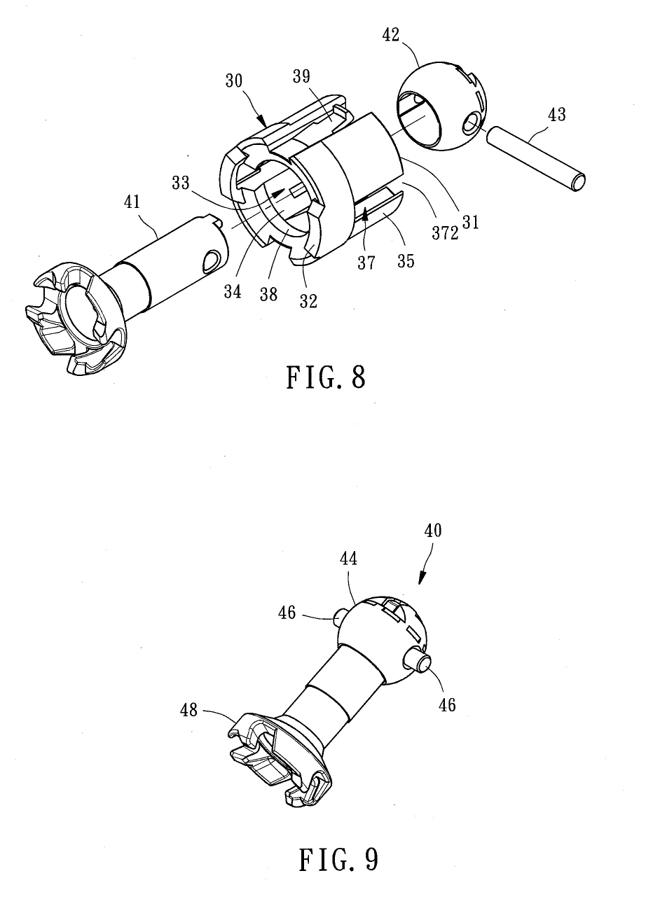

Referring to FIGS. 8-9, the driving member 40 includes a main body 41, a hollow open-ended spherical member 42, and a bar 43. The main body 41 has one end passing through the tunnel 33 and then sleeved into the open-ended spherical member 42 in such a way that a first end portion 44 is formed. The bar 43 is inserted through the main body 41 and the open-ended spherical member 42 to combine both of them in such a way that two protrusions 46 formed of two ends of the bar 43 extend outward from the first end portion 44 toward two opposite directions, respectively. The first end portion 44 is located inside the tunnel 33. The two protrusions 46 extend into the two limiting slots 37, respectively. The driving member 40 further includes a second end portion 48 located at the main body 41 and extending out of the second end 32 of the coupling member 30.

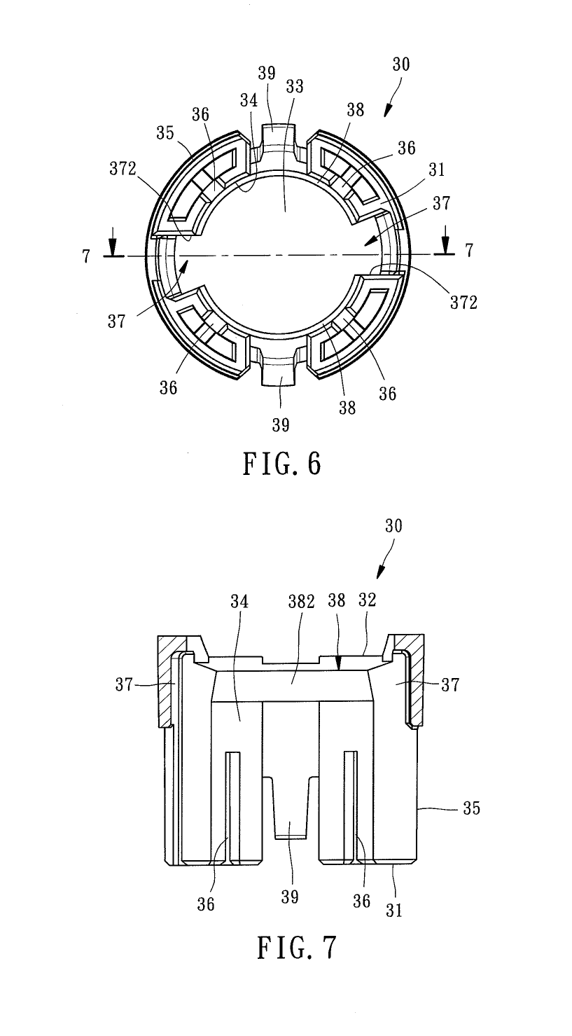

The limiting portions 38 of the coupling member 30 are adapted for preventing the first end portion 44 from disengagement from the tunnel 33 through the second end 32. In this embodiment, the limiting portions 38 of the coupling member 30 are close to the second end 32 and integrally protrude from the internal wall surface 34 and each include a limiting bevel 382, as shown in FIG. 7, inclined inwardly toward the second end 32 from a joint between the internal wall surface 34 and the corresponding limiting portion 38. As shown in FIGS. 6-8, each of the limiting slots 37 includes an entrance 372 located at the first end 31 for entry of the protrusions 46 of the driving member 40 and runs through the internal and external wall surfaces 34 and 35 in such a way that each of the protrusions 46 can enter the corresponding limiting slot 37 more easily. However, each of the limiting portions 38 is not limited to such shape and each of the limiting slots 37 can alternatively avoid running through the external wall surface 35.

In addition, each of the limiting portions 38 can be not necessarily formed integrally from the coupling member 30 but can be an individual limiter (not shown) mounted to the second end 32 of the coupling member 30. The driving member 40 can alternatively be formed in one piece.

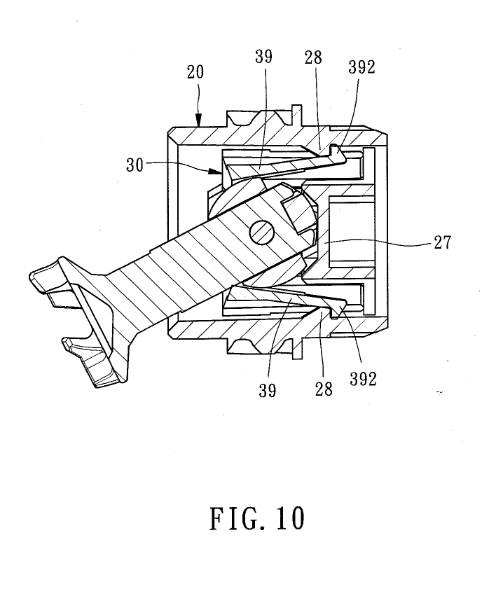

Referring to FIG. 2 again, after the coupling member 30 is combined with the driving member 40, the first end 31 is mounted inside the shell 20, while facing the bottom portion 22, and the shell 20 is fixed to one end of a photosensitive roller (not shown) beforehand. In the process of combination of the coupling member 30 and the shell 20, the two springy portions 39 are movable along the two respective guiding bevels 286 of the two convexities 28 and meanwhile forced to deformably retract inwardly until the two hook pieces 392 engage the respective bottom sides 282 of the convexities 28, as shown in FIG. 10; moreover, the fitting slots 36 engage the respective ribs 222. In this way, the coupling member 30 and the shell 20 are fastened with each other and the first end portion 44 is confined between the limiting portion 38 and the bottom portion 22, so the driving member 40 is axially movable within a very small distance. Besides, the driving member 40 is pivotable within a range for a very small angle because the protrusions 64 are restricted within the limiting slots 37, respectively. When the second end portion 48 of the driving member 40 is driven by a driving shaft (not shown) mounted inside a printer for rotation, the coupling member 30, the shell 20, and the photosensitive roller can be driven for rotation. Please note that the guiding bevel 286 can be unnecessarily formed on the convexity 28 as per actual requirement.

Before the photosensitive drum using the driving gear 10 of the present invention is finished to leave the factory, the assembler can fasten the shell 20 to the photosensitive roller independently without hardship due to none of any interference of the driving member 40. Besides, the vendors can provide the photosensitive roller and the shell 20 which have been fixedly connected with each other for the user to detach and install the original coupling member 30 and the driving member 40 to a new shell 20. As long as the assembler or the user aims the springy portions 39 at the convexities 28 to plug the coupling member 30 into the shell 20, it will be very easy to put the shell 20 and the coupling member 30 together. Besides, as long as the user pulls the driving member 40 outward, the springy portions 39 can be forced to deformably retract inward to further separate the two hook pieces 392 from the two convexities 28. In other words, no matter when the user installs the driving gear 10 to the photosensitive roller for the first time or mounts the driving member 40 and the coupling member 30 to the shell 20 and a new photosensitive roller instead of the damaged one, it will not be difficult for the user to install or detach the driving gear 10.

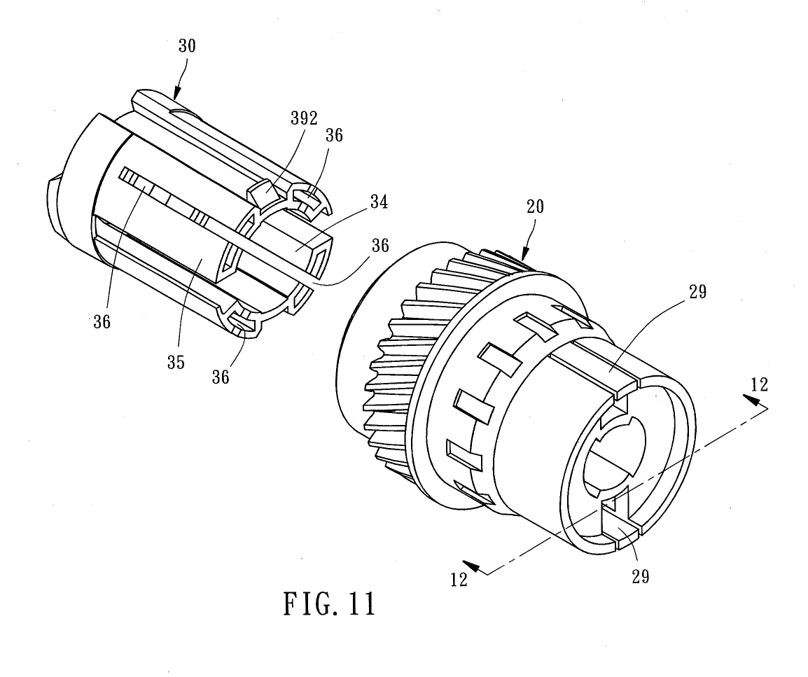

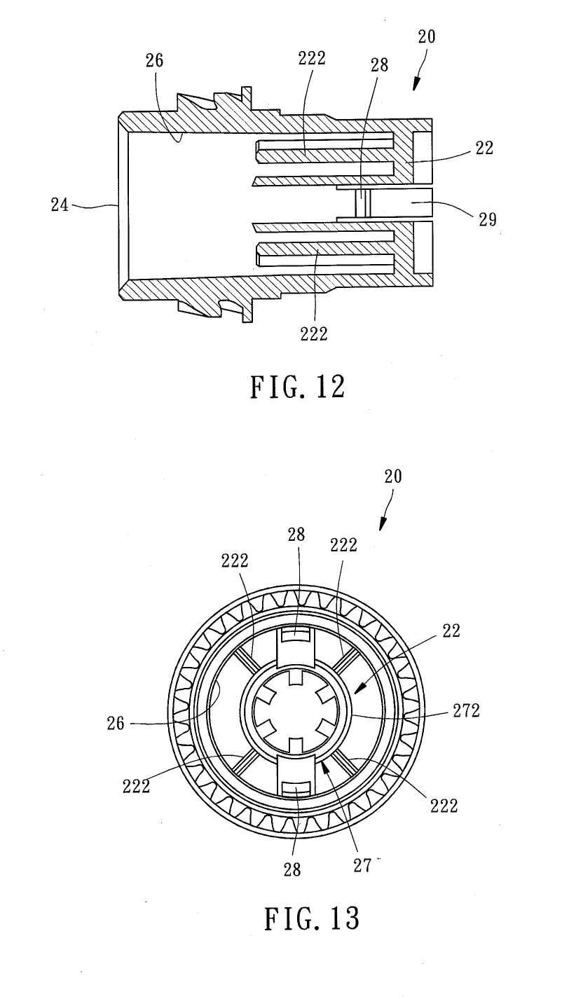

In the first embodiment, the coupling member 30 can be combined with or detached from the shell 20 by the springy portion 39 which can deformably retract inward. However, how the coupling member 30 and the shell 20 are put together is not limited to the aforesaid way. For example, referring to FIG. 11, in a driving gear constructed according to a second preferred embodiment of the present invention, the hook pieces 392 of the coupling member 30 are immobile and the shell 20 includes two springy parts 29. Besides, the two convexities 28 of the shell 20 for engaging the hook pieces 392 are located at respective internal sides of the springy portions 29, as shown in FIG. 12. The two springy parts 29 can be forced to resiliently deformably expand outward to combine or separate the two hook pieces 392 and two convexities 28 with or from each other.

In the first embodiment, the ribs 222 of the shell 20 are connected with an external periphery 272 of the support portion 27, as shown in FIG. 3, without extending to the inner surface 26, and the fitting slots 36 of the coupling member 30 are located on the internal wall surface 34 without running through the external wall surface 35, as shown in FIG. 5. However, as shown in FIGS. 11-13, the ribs 222 of the shell 20 can extend from the external periphery 272 to the inner surface 26 and the fitting slots 36 can run through the internal and external wall surfaces 34 and 35. Further, in an alternate design, the support potion 27 can be eliminated.

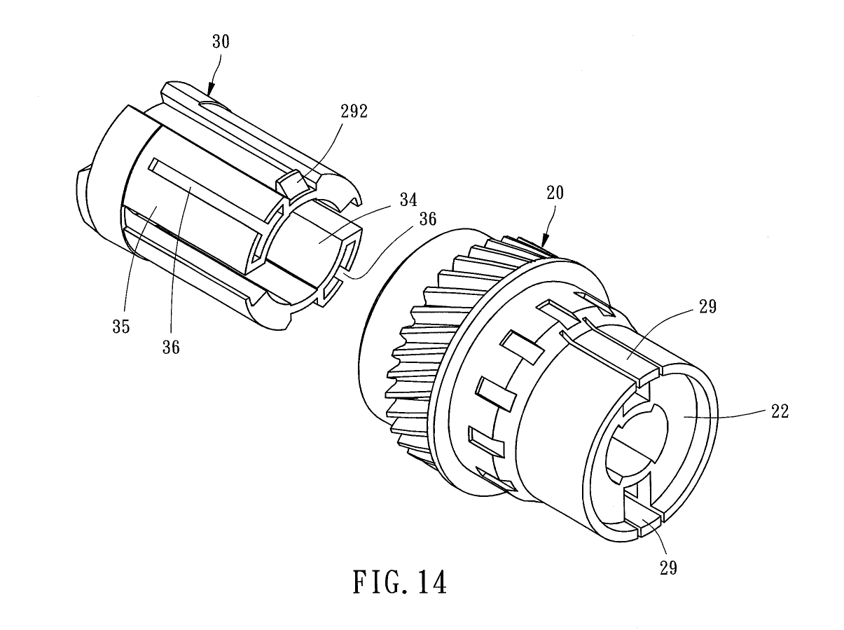

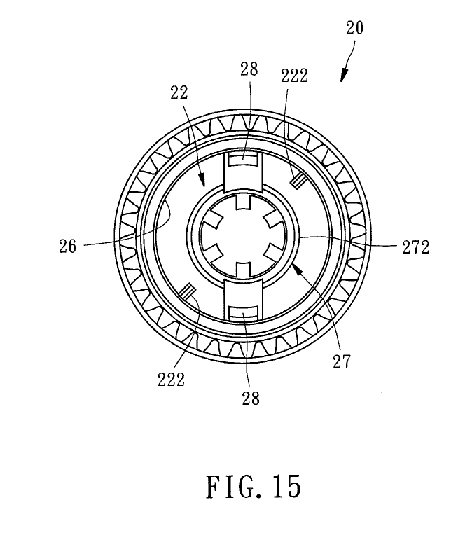

Referring to FIGS. 14-15, in a third preferred embodiment of the present invention, the ribs 222 of the shell 20 can be connected with the inner surface 26 without extending to the external periphery 272 of the support portion 27 and the fitting slots 36 of the coupling member 30 can be provided at the external wall surface 35 without running through the internal wall surface 34. Besides, the shell 20 can have two ribs 222 and the coupling member 30 can have two fitting slots 36. In fact, the shell 20 can only need to have at least one rib 222 and the coupling member 30 can only need to have at least one fitting slot 36.

Although the present invention has been described with respect to specific preferred embodiments thereof, it is in no way limited to the specifics of the illustrated structures but changes and modifications may be made within the scope of the appended claims.

What is claimed is:

1. A driving gear for a photosensitive drum, comprising:
a shell having a bottom portion, an opening opposite to the bottom portion, an inner surface located between the opening and the bottom portion, two convexities protruding from the inner surface, and at least one rib located at the bottom portion, each of the convexities having a bottom side facing the bottom portion;
a coupling member having a first end, a second end opposite to the first end, a tunnel extending to the second from the first end, an internal wall surface located inside the tunnel, a limiting slot recessed from the internal wall surface, two hook pieces protruding outward, at least one fitting slot recessed toward the second end from the first end, and a limiting portion located inside the tunnel, the limiting slot having an entrance located at the first end, the coupling member being detachably mounted inside the shell in a way that the first end of the coupling member faces the bottom portion of the shell, each of the two hook pieces is engaged with one of the bottom sides of the two convexities, and the at least one fitting slot is engaged with the at least one rib; and
a driving member having a first end portion mounted inside the tunnel, a second end portion extending out of the second end of the coupling member, and at least one protrusion protruding from the first end portion, the first end portion being confined between the limiting portion of the coupling member and the bottom portion of the shell, the protrusion being located inside the limiting slot of the coupling member.

2. The driving gear as defined in claim 1, wherein the coupling member comprises an external wall surface opposite to the internal wall surface and the limiting slot runs through the internal and external wall surfaces.

3. The driving gear as defined in claim 1, wherein the coupling member comprises two springy portions extending toward the first end from the second end; each of the two hook pieces is located at one of the two springy portions; the two springy portions can be forced to resiliently deform in such a way that the two hook pieces can be separated from the two hook pieces respectively.

4. The driving gear as defined in claim 1, wherein each of the convexities of the shell comprises a guiding bevel facing the opening of the shell; the guiding bevel and the bottom portion of the convexity are located at two sides of a vertex of the convexity respectively.

5. The driving gear as defined in claim 1, wherein the shell comprises two springy portions and the two convexities are located at the two springy portions respectively; the two springy portions are resiliently deformable under an external force to separate the two hook pieces from the two convexities respectively.

6. The driving gear as defined in claim 1, wherein the shell comprises four said ribs equidistantly and radially arranged at the bottom portion of the shell; the coupling member comprises four said fitting slots engaged with the four said ribs respectively.

7. The driving gear as defined in claim 1, wherein the shell further comprises a support portion located at a center of the bottom portion and provided with an external periphery; the at least one rib is connected with the external periphery of the support portion, and the fitting slot of the coupling member is located at the inner wall surface of the coupling member.

8. The driving gear as defined in claim 7, wherein the at least one rib of the shell is connected with the inner surface of the shell and the coupling member comprises an external wall surface opposite to the internal wall surface; the at least one fitting slot of the coupling member runs through the internal and external wall surfaces.

9. The driving gear as defined in claim 1, wherein the at least one rib is connected with the inner surface and the coupling member comprises an external wall surface opposite to the inner wall surface; the at least one fitting slot of the coupling member is located at the external wall surface.

10. The driving gear as defined in claim 1, wherein the driving member further comprises a main body, an open-ended spherical member mounted to an end of the main body to become the first end portion, and a bar inserted through the main body and the open-ended spherical member; two ends of the bar extend out of the open-ended spherical member to become two said protrusions.
